(19) United States
(12) Patent Application Publication
(10) Pub. No.: US 2007/0223760 A1
(43) Pub. Date: Sep. 27, 2007

(54) Personal speaker assembly mounted on user's neck

(76) Inventor: Eagle Fan, Chu-Pei City (TW)

Correspondence Address: LIN & ASSOCIATES INTELLECTUAL PROPERTY, P.O. BOX 2339, SARATOGA, CA, 95070-0339, US

(21) Appl. No.: 11/367,898

(22) Filed: Mar. 3, 2006

(51) Int. Cl. H04R 9/06; H04R 5/02; H04R 1/02

(52) U.S. Cl. 381/333; 381/301; 381/388

(57) ABSTRACT

A personal speaker assembly includes a wire connected between a plug and at least one speaker wherein the plug is connected with a music player. The wire is in a loop form so as to be mounted on the user's neck and the at least one speaker is arranged to be approximate to the user's ear so that the user can enjoy the music while the sound outside can be heard.

### BACKGROUND OF THE INVENTION

1. Field of the Invention

The present invention relates to a personal music speaker assembly with two speakers connected to a loop which includes a plug connected with a music player. The loop is mounted on the user's neck and the speakers are located close to the use's ears.

2. The Prior Arts

Along with the develop of compact music players, users can carry of music player conveniently without occupying too much space and the modern music players can store hundreds of songs so that the users can enjoy the music a using an ear set. Generally, the ear set includes a plug which is electrically connected with the music player and two ear phones which are inserted in the ears so that music can be brought into the user's ears with a very high quality of sound. However, there is a potential shortcoming if listening music by the ear set for a longer period of time, which is that the ears could be hurt by the close and loud voice form the ear phones. Besides, because the ear phones are filled in the ears so that the user cannot hear sound from outside and this affects the reaction of the users.

The present invention intends to provide a personal speaker assembly wherein the speakers are not positioned in the user's ears and the assembly can mounted on the user's neck and arrange the speakers to be proximate to the ears.

### SUMMARY OF THE INVENTION

The present invention relates to a personal speaker assembly which comprises a plug connected to a wire which is electrically connected at least one speaker. The wire can be mounted on a use's neck and the at least one speaker is located beneath the user's ear. The plug is connected with a music player so that the music can be heard by the user from the at least one speaker while the user's ear can also hear outside sound.

### BRIEF DESCRIPTION OF THE DRAWINGS

The present invention will be apparent to those skilled in the art by reading the following detailed description of a preferred embodiment thereof, with reference to the attached drawings, in which:

FIG. 1 shows the speaker assembly of the present invention;

FIG. 2 shows that the speaker assembly of the present invention is mounted on the user's neck;

FIG. 3 shows a second embodiment of the speaker assembly of the present invention;

FIG. 4 shows a third embodiment of the speaker assembly of the present invention;

FIG. 5 shows a user uses the third embodiment of the speaker assembly of the present invention; and

FIG. 6 shows a fourth embodiment of the speaker assembly of the present invention.

### DETAILED DESCRIPTION OF THE PREFERRED EMBODIMENT

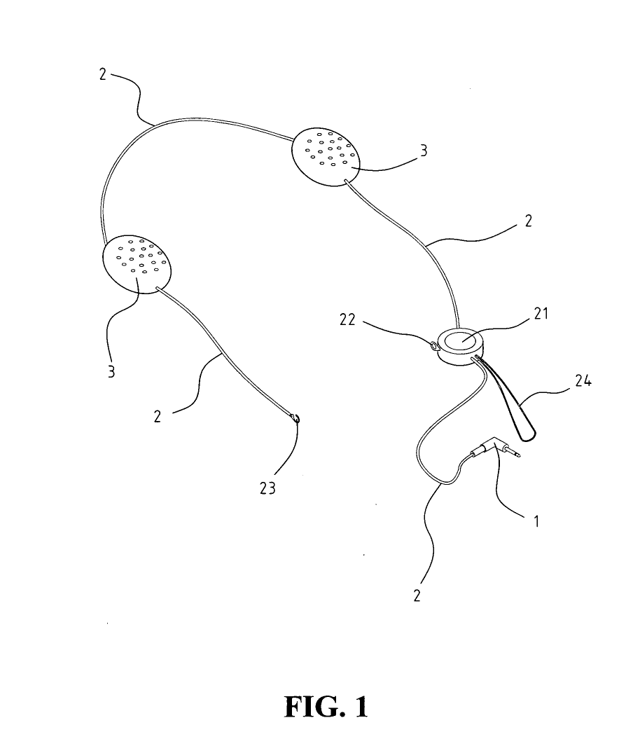

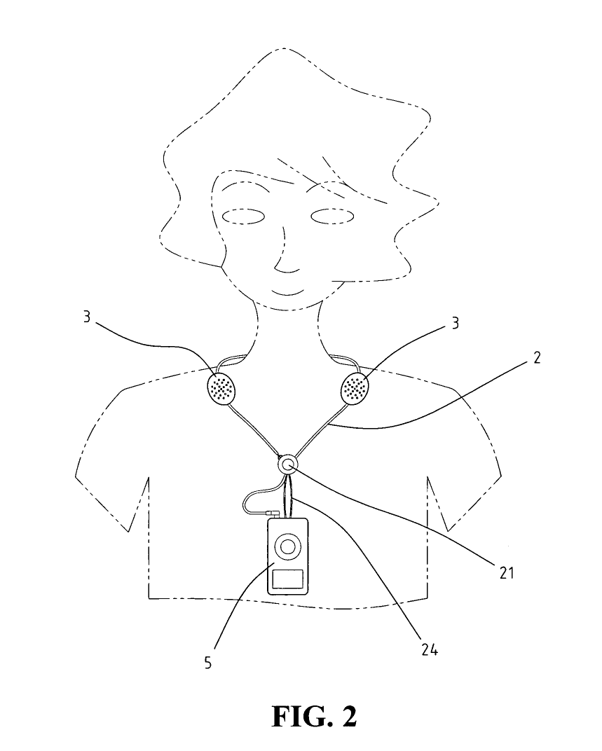

With reference to the drawings and in particular to FIGS. 1 and 2, the speaker assembly of the present invention a plug 1 connected to a first end of a wire 2 and the other end of the wire 2 is connected to two speakers 3. The plug 1 can be used with a music player such as CD player, MP3 player, cassette player or radio. The wire 2 includes electrical wires which are connected to the plug 1 and the speakers 3.

The wire 2 has a connection member 21 connected thereto and a first connection end 22 is connected to the connection member 21. A remote end of the wire 2 has a second connection end 23 which is connected with the first connection end 22 so as to form a loop which can be mounted on the user's neck. The plug 1 extends from the loop and is connected to a music player 5 which is connected to a hanging loop 24 on the connection member 21. The two speakers 3 are located beneath the user's ears so that the user can hear the music.

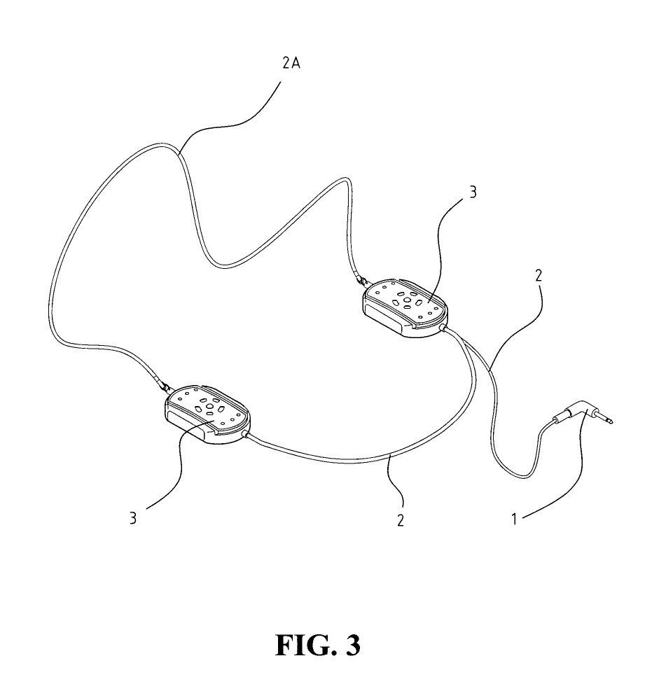

FIG. 3 shows a second embodiment of the speaker assembly of the present invention, wherein the wire 2 is connected between the two speakers 3 and the plug 1 is extended from the wire 2. A strip 2A is connected to the two speakers 3 such that the strip 2A and the wire 2 form a loop.

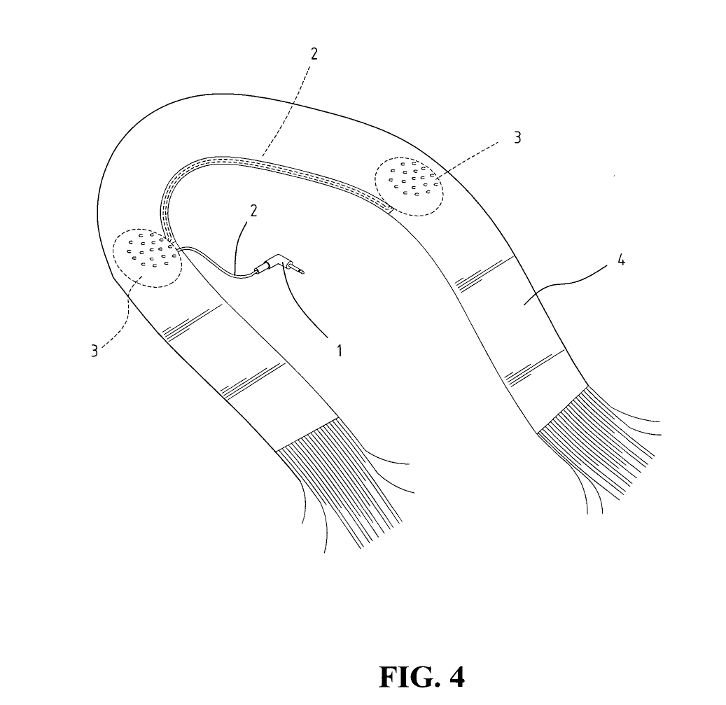

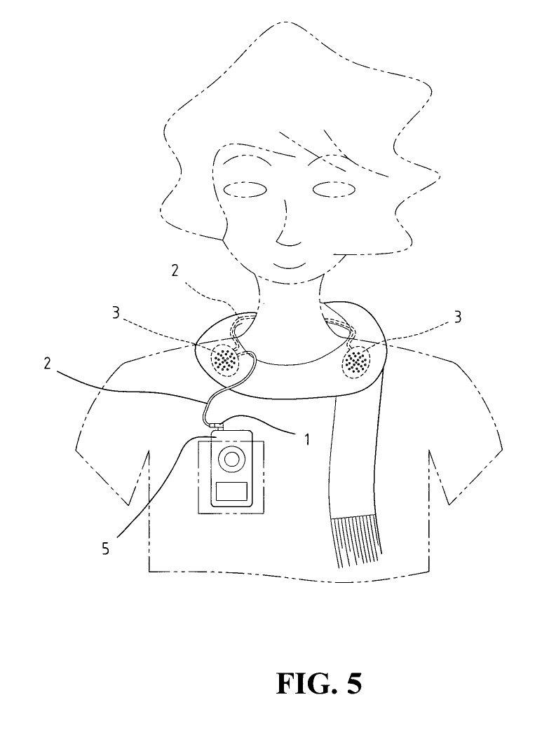

FIGS. 4 and 5 show a third embodiment of the speaker assembly of the present invention, wherein the wire 2 and the speakers 3 are received in a scarf 4. The wire 2 and the speakers 3 are enclosed and hidden by the scarf 4. The plug 1 and a section of the wire 2 extend out from the scarf 4 so as to be connected with the music player 5 as shown in FIG. 5.

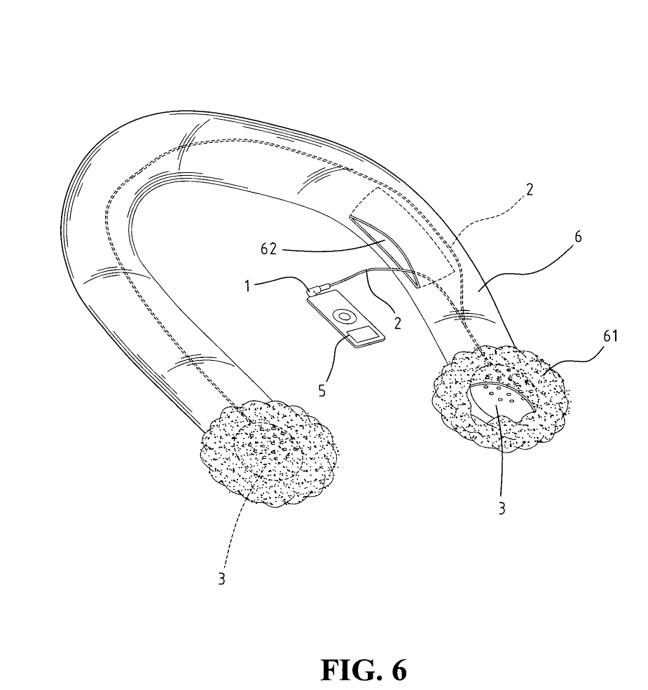

FIG. 6 shows a fourth embodiment of the speaker assembly of the present invention wherein the scarf 6 is a tubular scarf and two decoration members 61 are connected to two ends of the scarf 6. The speakers 3 are enclosed by the decoration members 61 respectively, and the wire 2 connected between the two speakers 3 are also enclosed by the scarf 6. A section of the wire 2 with the plug 1 extend out from an independent space in the scarf 6. The independent space can be a pocket 62 and the music player 5 connected to the plug 1 and the plug 1 and the music player 5 can be received in the pocket 62.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A personal speaker assembly comprising:
a plug connected to a first end of a wire and the other end of the wire connected to at least one speaker.

2. The assembly as claimed in claim 1, wherein the wire has a connection member connected thereto and a first connection end is connected to the connection member, the wire has a second connection end which is connected with the first connection end.

3. The assembly as claimed in claim 1, wherein the wire is in a form of a loop and the plug extends from the loop.

4. The assembly as claimed in claim 1, wherein the wire and the at least one speaker are received in a scarf.

5. The assembly as claimed in claim 4, wherein the wire is enclosed by the scarf.

6. The assembly as claimed in claim 4, wherein the scarf is a tubular scarf and two decoration members are connected to two ends of the scarf, the at least one speaker is enclosed by one of the decoration members, the wire extends out from an independent space in the scarf.

7. The assembly as claimed in claim 6, wherein the independent space is a pocket and the plug and the wire extend out from the pocket.

8. The assembly as claimed in claim 7, wherein a music player is connected to the plug and both of which are received in the pocket.

9. A personal speaker assembly comprising:
a plug connected with a music player;
a wire connected between the plug and at least one speaker which is adapted to be arranged beneath a user's ear; and
a scarf enclosing the at least one speaker and the wire.
